(19) United States
(12) Patent Application Publication
(10) Pub. No.: US 2014/0262403 A1
(43) Pub. Date: Sep. 18, 2014

(54) TWO-SIDED SWITCH AND HANDLE FOR A POWER SAW

(71) Applicants: Robert Bosch GmbH, Stuttgart (DE); Robert Bosch Tool Corporation, Broadview, IL (US)

(72) Inventor: Matthew M. Rybka, Hoffman Estates, IL (US)

(73) Assignees: Robert Bosch GmbH, Stuttgart (DE); Robert Bosch Tool Corporation, Broadview, IL (US)

(21) Appl. No.: 14/207,801

(22) Filed: Mar. 13, 2014

Related U.S. Application Data
(60) Provisional application No. 61/781,404, filed on Mar. 14, 2013.

(51) Int. Cl. B25F 5/02

(52) U.S. Cl. CPC B25F 5/02
USPC 173/170

(57) ABSTRACT

A two-side switch and handle system includes a handle housing including a gripping portion and switch mechanism mounted to the housing portion. The switch mechanism includes a paddle that is movable between a first and second position. An actuator is configured to be moved between an ON position to close a power circuit and an OFF position to open a power circuit within the handle housing. A protrusion projects outwardly from a trailing end portion of the paddle adjacent the gripping portion of the handle housing. The gripping portion defines a handle plane and the switch mechanism defines a switch plane. The switch mechanism is arranged on the front portion of the handle housing such that the switch plane is angled downwardly from the handle plane by an acute angle.

### CROSS-REFERENCE TO RELATED APPLICATIONS

This application claims priority to U.S. Provisional Application Ser. No. 61/781,404 entitled “TWO-SIDED SWITCH AND HANDLE FOR A POWER SAW” by Rybka, filed Mar. 14, 2013, the disclosure of which is hereby incorporated herein by reference in its entirety.

### TECHNICAL FIELD

The present disclosure relates to a power saw, and, more particularly, to a flooring power saw.

### BACKGROUND

Laminate flooring is a popular flooring product due to its ease of installment as well as its performance. Additionally, the various designs which are available for laminate flooring enhance its popularity with consumers. The designs include wood-grain patterns, slate, marble, mosaic, and granite. Additionally, a number of specialized products have been designed to ease installation of laminate flooring. Such products include transition strips, end caps, stair nosings, moldings and baseboards.

One difficult aspect of installation that remains, however, is cutting the laminate flooring to fit within a particular area. Most laminates are provided in planks that are 7-8 inches wide and about 4 foot long. Depending upon the width of a room, the final course of planks may need to be ripped to the appropriate width. Moreover, the lengths of the planks at opposing walls need to be trimmed. Additionally, miter cuts may be required to contour the planks to fit the contours of a particular room.

Traditionally, a number of different types of saws have been used to make the necessary miter and rip cuts in laminate floors. Such saws include table saws, hand saws, jig saws and circular saws. Each of these types of saws provides some advantages. A table saw gives very precise cuts and can be used to rip cut a work-piece. Additionally, table saws can be configured to provide angled cuts by angling the work-piece. Table saws, even the “portable” table saws, however, are large and heavy. Thus, an installer must either accept the difficulty in transporting the table saw near the area where the laminate is to be installed or carry each piece of laminate back and forth from the work area to the saw location. Additionally, many homeowners attempt to install a laminate floor on their own. In the event the homeowner does not own a table saw, a different approach is needed.

To address these difficulties, a portable laminate flooring saw has been developed that can be used to perform both miter cuts and rip cuts in laminate floors. Such a saw is depicted in FIGS. 1 and 2. The portable laminate flooring saw system 10 includes a base 12, a support structure 14, and a fence 16. A power cutting tool 18 is supported by the support structure 14. The support structure 14 includes two support bars 24, 26. The power tool 18 is slidably supported on the support bars 24, 26 by a housing 28. A momentary power switch 30, or trigger, and a lockout switch 32 are provided near a grip 34 of the power tool 18. The trigger 30 is used for momentarily powering the motor of the tool when the power tool is being used to perform miter cuts in which the power tool 18 is moved with respect to a workpiece, such as a piece of laminate flooring, braced against the base. A bump switch 36 is located on a front portion of the power tool housing 28. The bump switch 36 is configured to provide continuous power to the motor of the saw which allows the saw to be used to perform rip cuts in which power tool 18 is locked in position and a workpiece is moved across the base with respect to the power tool.

While effective, the configuration of the handle and positioning of the switches can cause confusion as to which switch should be activated and when. In addition, additional internal mechanisms must be in place to control which switch is active and arbitrate between the switches for power control of the saw. As a result, the switch configuration of the flooring saw can be complex and have a high cost.

### BRIEF DESCRIPTION OF THE DRAWINGS

FIG. 1 is a perspective view of a laminate flooring saw system having a handle in accordance with the prior art.

FIG. 2 is a perspective view of the prior art handle of the flooring saw of FIG. 1;

FIG. 3 is a side perspective view of a handle in accordance with the disclosure for use with a flooring saw as depicted in FIG. 1;

FIG. 4 is a front perspective view of the handle of FIG. 3;

FIG. 5 is a cross-sectional view of the handle of FIG. 3 showing the switch mechanism on the interior of the handle;

FIG. 6 is a cross-sectional view of the handle and the switch mechanism of FIG. 5.

FIG. 7 is a perspective view of the switch mechanism of the handle of FIG. 3 shown separated from the handle and with the lockout key inserted.

FIG. 8 is a perspective view of the switch mechanism of the handle shown separated from the handle and with the lockout key removed.

FIG. 9 is a cross-sectional view of the switch mechanism of FIG. 7.

FIG. 10 is a fragmentary, cross-sectional view of the handle of FIG. 3 showing the switch-mechanism and lockout key in cross-section.

### DESCRIPTION OF THE PRESENT INVENTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to a person of ordinary skill in the art to which this disclosure pertains.

The disclosure is directed to a two-sided switch and handle system for a portable power tool, such as a laminate flooring saw. The two-sided switch may also be used in other types of power tools with similar handle arrangements, such as circular saws, band saw, and the like. As explained below, two-sided switch and handle system has a configuration that enables the bump switch to be used as the power switch for performing both miter cuts and rip cuts and with the operator positioned on either side of the tool. In addition, the handle is shaped so that an operator can access the bump switch with the same hand that is used to grasp the gripping portion of the handle without removing the hand from the handle. Thus, the bump switch can be used for both modes of operation and with the operator on either side of the tool. As a result, the trigger switch provided on the handles of previously known flooring is no longer required.

In one embodiment, a switch and handle system for a power tool is provided. The system includes a handle housing having a gripping portion. A power circuit is provided in the handle housing that electrically connects a power input for the power tool to a power output. A switch mechanism is mounted to the handle housing that includes a paddle portion located on an exterior of the handle housing adjacent the gripping portion. The switch mechanism has a paddle portion extending forwardly from the handle housing in a direction away from the gripping portion and including a leading end portion. The paddle portion is movable between a first position and a second position. The switch mechanism includes an actuator configured to be moved between an ON position to close the power circuit and an OFF position to open the power circuit by the paddle portion. A protrusion projects outwardly from a trailing end portion of the paddle portion. The gripping portion defines a handle plane and the switch mechanism defines a switch plane. The switch mechanism is arranged on the front portion of the handle housing such that the switch plane is angled downwardly from the handle plane by an acute angle. In one embodiment, the acute angle is between 20° and 60°.

The system may include a lockout key that is removably inserted through the paddle portion and into the actuator and that couples the actuator to the movement of the paddle portion when installed. The lockout key decouples the actuator from the movement of the paddle portion when it is removed. In one embodiment, the protrusion is provided on the lockout key. In this embodiment, the paddle portion defines a first opening, the actuator defines a second opening, and the lockout key includes a post portion that is inserted through the first opening and into the second opening when installing the lockout key. The first opening aligns with the second opening to allow the post portion to be inserted into the second opening.

In one embodiment, a power cord is connected to the handle housing, and the power input is connected to the power cord. The handle housing may further comprise a mounting portion configured to secure the handle housing to the power tool. The gripping portion does not need to have a power switch separate from the switch mechanism.

The paddle portion is configured to be manually moved from the first position to the second position by an application of pressure to an underside of the leading end portion of the paddle portion, and also to be manually moved from the first position to the second position by an application of pressure to a leading side of the protrusion. The paddle portion is configured to be manually moved from the second position to the first position by an application of pressure to a top side of the leading end portion of the paddle portion and also to be manually moved from the second position to the first position by an application of pressure to a trailing side of the protrusion. The actuator may be configured to be in the ON position when the paddle portion is in the second position and in the OFF position when the paddle portion is in the first position.

In another embodiment, a power tool system is provided that includes a motor housing, a motor supported in the housing configured to drive a work element, and a power circuit that electrically connects the motor to a power input. The power tool system also includes a switch and handle system having a handle housing with a gripping portion and a switch mechanism mounted to the handle housing. The switch mechanism includes a paddle portion that is located on an exterior of the handle housing adjacent the gripping portion, the paddle portion extending forwardly from the handle housing in a direction away from the gripping portion and including a leading end portion. The paddle portion is movable between a first position and a second position in relation to the handle housing. An actuator is movably supported within the handle housing and operably coupled to the power circuit. The actuator is configured to be moved between an ON position to close the power circuit and an OFF position to open the power circuit. A protrusion projects outwardly from a trailing end portion of the paddle portion adjacent the gripping portion of the handle housing. The gripping portion defines a handle plane and the switch mechanism defines a switch plane. The switch mechanism is arranged on the front portion of the handle housing such that the switch plane is angled downwardly from the handle plane by an acute angle.

Referring now to the drawings, an embodiment of a two-sided switch and handle system 100 for a power tool is depicted in FIG. 1. The system 100 includes a handle housing 104 and switch mechanism 106. The handle housing 104 is formed of a durable, lightweight material, such as hard plastic. In one embodiment, the handle housing comprises two housing shell halves that are designed to be secured together in a clamshell configuration and form an enclosure that surrounds the internal wiring and circuitry of the system.

In the embodiment of FIGS. 1-3, the handle housing 104 includes a mounting portion 108, a gripping portion 110, a front portion 112 that extends between the mounting portion 108 and the gripping portion 110 at a leading end of the handle housing, and a rear portion 114 that extends between the mounting portion 108 and the gripping portion 110 at the trailing end of the handle housing. The gripping portion 110 is sized, shaped, and contoured to provide an ergonomic feel for the operator when using the power tool. The mounting portion is configured to be mounted onto the motor housing of a power tool, such as a portable laminate flooring saw as depicted in FIG. 1. The mounting portion may be secured to the housing of the power tool in any suitable manner, e.g., by fasteners, such as screws or bolts (not shown).

The gripping portion 110 is spaced apart from the mounting portion by the front and rear portions 112, 114 of the housing. The gripping portion 110, mounting portion 108, and front and rear portions 112, 114 define an opening 116 which allows an operator's hand to grasp and surround the gripping portion of the housing. The gripping portion 18 is arranged so that it extends generally horizontally over the mounting portion. As best seen in FIGS. 2 and 3, the gripping portion is angled slightly upwardly as it extends from the rear portion 114 to the front portion 112. This orientation allows an operator to grip the handle comfortably when the power tool is used from a low position, such as when placed on the floor, and the operator is working from a position that is generally above the power tool. In alternative embodiments, the handle housing, and particularly the gripping portion, may be provided in variety of sizes, shapes, configurations, and/or orientations.

The switch mechanism 106 is positioned on an outer side of the handle housing 104 in a position that can be manipulated by the thumb of an operator's hand while the hand is grasping the gripping portion of the handle housing. In the embodiment of FIGS. 3-6, the switch mechanism 106 is located on the front portion 112 of the housing adjacent the leading end of the gripping portion 110 although the switch mechanism may also be considered to be provided on the leading end of the gripping portion.

The switch mechanism 106 is operably connected to a power circuit provided within the handle housing which is configured to provide power to the power tool upon which the handle system is mounted. The power circuit is configured to provide power for energizing the motor of the tool as well as other electrical components that the tool may include. The power circuit includes an input connection 118 and an output connection 120. The input connection 118 receives power from the power source of the power tool, and the output connection 120 connects to a power circuit provided in the motor housing of the power tool for delivering power to the motor. Although not depicted, the power circuit may include other components as needed for controlling, regulating, and/or limiting voltage and/or current in the power circuit.

In the embodiment of FIGS. 3-6, the power input connection 118 receives power from a power cord 122 which connects the power circuit to an external power source, such as an AC outlet. The power cord is connected to the rear portion 114 of the handle housing. In alternative embodiments, a power cord may be attached to the motor housing or another part of the housing such that the input connection is connected to a power feeder extending from the motor housing or other part of the power tool. In another alternative embodiment, the power source may comprise an internal power source, such as a rechargeable battery, incorporated into the handle housing or another part of the power tool, in which case, the input connection would be connected to the battery supply circuitry. Referring to FIGS. 5 and 6, the power circuit includes a supply conductor 124 and a ground conductor 126. At least one of the supply and ground conductors, e.g., the supply conductor, is routed to the switch mechanism 106 from the input 118 and then routed from the switch mechanism 106 to the output 120.

The switch mechanism 106 comprises a two-position switch which is configured to close the power circuit in a first position, or ON position, and to open the power circuit in a second position, or OFF position. The switch mechanism is a mechanical switch which is configured to be moved between the OFF and ON positions manually by operator of the tool. Referring to FIGS. 7-10, the switch mechanism 106 includes an actuator 128, a paddle 130, and a lockout key 132. The actuator 128 is movably supported within the switch housing 134 and is configured to close the power circuit in the ON position and open the power circuit in the OFF position. The actuator may be configured to pivot between the OFF position and the ON position. The paddle portion 130 comprises a lever located on the exterior the handle housing 104 for moving the actuator between the OFF and ON positions. The lockout key 132 fixedly connects the paddle portion 130 to the actuator 128 so that the actuator can be moved by the paddle portion.

Referring to FIGS. 3-6, the paddle portion 130 extends from the actuator 128 beyond the front portion of the handle housing such that a leading end portion 136 (e.g., the portion located farthest in the forward direction) of the paddle 130 is located forwardly of the handle housing 104. This position enables the paddle 130 to be accessed and manipulated via the leading end portion 136 of the paddle by applying pressure upwardly or downwardly in order to pivot the paddle 130 and move the actuator 128 between the OFF and ON positions. This position is useful for operating the power tool when the operator is positioned in front of the power tool, such as when the power tool is being used to perform rip cuts. The operator can turn the power tool on from the front of the power tool so that continuous power is supplied to the power tool while the operator moves a workpiece, such as a piece of laminate flooring, with respect to the power tool. The operator can then easily bump the switch to the off position to cut off power to the tool.

The paddle portion 130 and actuator 128 are arranged so that the paddle portion 130 is located adjacent the handle housing 104 when the actuator 128 is in the OFF position and is pivoted upwardly in direction A from this position to the ON position. As can be seen in FIGS. 3-6, the front portion 112 of the housing 104 includes a paddle guard portion 138 that is extends from the handle housing below the leading end portion 136 of the paddle 130 to protect the underside of the paddle from being inadvertently hit or bumped upwardly toward the ON position.

The lockout key 132 is removable from the switch mechanism 106 to decouple actuator 128 from the paddle portion 130 so that the actuator 128 is no longer movable by and with the paddle portion. Referring to FIGS. 7-10, the lockout key 132 includes a head portion 140 and a post portion 142. The actuator 128 includes a recess or opening 144 which is configured to receive the post portion 142 of the lockout key 132, and the paddle portion 130 defines an opening 146 through which the post 142 is extended when inserting the post 142 into the actuator opening 144. The opening 146 in the paddle portion 130 must be aligned with the opening 144 in the actuator 128 to form a passage that allows the post portion 142 to be installed in the actuator.

The paddle portion 130 defines recess 148 in which the head portion 140 of the lockout key 132 is seated when the post 142 of the lockout key 132 is installed in the actuator 130. The head portion 140 of the lockout key includes an inner surface and an outer surface. As best seen in FIG. 10, when the lockout key 132 is installed, the inner surface of the head portion 140 is positioned against the bottom of the recess 148 in the paddle portion and the outer surface is substantially aligned with the outer surface of the paddle portion.

The switch mechanism 106 is configured to be used to control power to the tool when the power tool is being used to perform miter cuts. To perform miter cuts, a workpiece (not shown) is braced on the base 12 (FIG. 1) and the power tool is moved with respect to the workpiece along the support bars 24, 26 (FIG. 1) to perform cuts. In this mode of operation, the operator's hand is typically placed on the handle of the housing to control the movement and position of the power tool while the other hand is used to brace the workpiece on the base. To enable the switch mechanism 106 to be manipulated by the same hand of the operator used to grip the handle, a protrusion 150, or ridge, is provided on the switch mechanism adjacent the gripping portion 110 to facilitate the pivoting of the paddle portion 130 via the trailing end portion 152 which is closest to the gripping portion 110 of the handle.

In the embodiment of FIGS. 3-10, the protrusion or ridge 150 is provided on the outer surface of the head portion 140 of the lockout key 132 adjacent the trailing edge 152. The protrusion or ridge 150 extends laterally across the width of the head portion 140 of the lockout key and protrudes from the outer surface far enough to protrude beyond the outer surface of the paddle portion 130. In alternative embodiments, the protrusion or ridge may be provided on the paddle portion, such as a portion arranged on a trailing side of the head portion of the lockout key.

The orientation and positioning of the gripping portion 110 in relation to the paddle portion and the protrusion or ridge on the lockout key is designed to facilitate manipulation of the paddle portion 130 by an operator applying pressure on the protrusion or ridge with the tip of the thumb of the operator's hand that is gripping the handle 110. Referring to FIG. 10, the orientation of the gripping portion 110 of the handle defines a handle plane G, and the switch mechanism 106 defines a second plane H. The paddle portion 130 is arranged generally parallel to the second plane H when in the OFF position. As can be seen in FIG. 10, the gripping portion, the front portion, and the paddle portion are arranged such that the second plane is angled downwardly from the first plane such that an acute angle X is formed. In one embodiment, the acute angle X is in a range from 20° to 60°.

The arrangement of the gripping portion 110 and the switch mechanism 106 in FIGS. 2-10 facilitates movement of the paddle portion 130 from the OFF position to the ON position by applying pressure on the protrusion or ridge 150 in a direction C that is generally rearward toward the gripping portion 110. This is a natural movement for the thumb to perform when the hand is gripping the handle. Arranging the gripping portion 110 and the switch 106 such that the angle X is increased would require a greater amount of force to be applied transverse to the handle plane to pivot the paddle portion which is not a natural movement for the thumb to perform with the hand arranged on the gripping portion of the handle.

The two-sided switch and handle system describe above may be used to actuate a power tool, such as a portable laminate flooring saw, from a position at the front of the power tool, e.g. e.g., by applying pressure to the underside of the leading end portion 136 of the paddle 130 of the switch in the direction of arrow A to turn the tool on and applying pressure to the top side of the paddle 130 in the direction of arrow B to turn the tool off. The system also enables the tool to be actuated from a position at the rear of the power tool, e.g., by applying pressure to the leading side of the protrusion or ridge 150 on the lockout key 132 in the direction of arrow C to turn the tool on and by applying pressure to the trailing side of the protrusion or ridge 150 in the direction of arrow D to turn the tool off. Thus, a single switch and lockout mechanism can be provided which can be used easily from different positions and operating modes to control power to a power tool. The switch configuration allows a separate trigger mechanism on the handle to be dispensed with. The reduction in parts results in a less complex switching mechanism as well as a reduction in cost of manufacturing.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A switch and handle system for a power tool, the system comprising:
a handle housing including a gripping portion;
a power circuit in the handle housing that electrically connects a power input to a power output of the power tool;
a switch mechanism mounted to the handle housing, the switch mechanism including:
a paddle portion that is located on an exterior of the handle housing adjacent the gripping portion, the paddle portion extending forwardly from the handle housing in a direction away from the gripping portion and including a leading end portion, the paddle portion being movable between a first position and a second position in relation to the handle housing; and
an actuator movably supported within the handle housing and operably coupled to the power circuit, the actuator being configured to be moved between an ON position to close the power circuit and an OFF position to open the power circuit; and
a protrusion that projects outwardly from a trailing end portion of the paddle portion, the protrusion being positioned adjacent the gripping portion of the handle housing,
wherein the gripping portion defines a handle plane and the switch mechanism defines a switch plane, and
wherein the switch mechanism is arranged on the front portion of the handle housing such that the switch plane is angled downwardly from the handle plane by an acute angle.

2. The system of claim 1, further comprising:
a lockout key that is removably inserted through the paddle portion and into the actuator, the lockout key coupling the actuator to the movement of the paddle portion when installed, the lockout key decoupling the actuator from the movement of the paddle portion when removed.

3. The system of claim 2, wherein the protrusion is provided on the lockout key.

4. The system of claim 3, wherein the paddle portion defines a first opening,
wherein the actuator defines a second opening,
wherein the lockout key includes a post portion that is inserted through the first opening and into the second opening to install the lockout key, the first opening aligning with the second opening to allow the post portion to be inserted into the second opening.

5. The system of claim 4, further comprising:
a power cord connected to the handle housing,
wherein the power input is connected to the power cord.

6. The system of claim 5, wherein the handle housing further comprises a mounting portion configured to secure the handle housing to the power tool.

7. The system of claim 4, wherein the gripping portion does not include a power switch separate from the switch mechanism.

8. The system of claim 7, wherein the paddle portion is configured to be manually moved from the first position to the second position by an application of pressure to an underside of the leading end portion of the paddle portion, and
wherein the paddle portion is also configured to be manually moved from the first position to the second position by an application of pressure to a leading side of the protrusion.

9. The system of claim 8, wherein the paddle portion is configured to be manually moved from the second position to the first position by an application of pressure to a top side of the leading end portion of the paddle portion, and
wherein the paddle portion is also configured to be manually moved from the second position to the first position by an application of pressure to a trailing side of the protrusion.

10. The system of claim 9, wherein the actuator is configured to be in the ON position when the paddle portion is in the second position and in the OFF position when the paddle portion is in the first position.

11. The system of claim 1, wherein the acute angle is within a range of 20° to 60°.

12. A power tool system comprising:
a motor housing;
a motor supported within the housing, the motor being configured to drive a work element;
a power circuit that electrically connects the motor to a power input; and
a switch and handle system including:
a handle housing having a gripping portion;
a switch mechanism mounted to the handle housing, the switch mechanism including:
a paddle portion that is located on an exterior of the handle housing adjacent the gripping portion, the paddle portion extending forwardly from the handle housing in a direction away from the gripping portion and including a leading end portion, the paddle portion being movable between a first position and a second position in relation to the handle housing; and
an actuator movably supported within the handle housing and operably coupled to the power circuit, the actuator being configured to be moved between an ON position to close the power circuit and an OFF position to open the power circuit; and
a protrusion that projects outwardly from a trailing end portion of the paddle portion, the protrusion being positioned adjacent the gripping portion of the handle housing,
wherein the gripping portion defines a handle plane and the switch mechanism defines a switch plane, and
wherein the switch mechanism is arranged on the front portion of the handle housing such that the switch plane is angled downwardly from the handle plane by an acute angle.

13. The system of claim 12, further comprising:
a lockout key that is removably inserted through the paddle portion and into the actuator, the lockout key coupling the actuator to the movement of the paddle portion when installed, the lockout key decoupling the actuator from the movement of the paddle portion when removed.

14. The system of claim 13, wherein the protrusion is provided on the lockout key.

15. The system of claim 14, wherein the paddle portion defines a first opening,
wherein the actuator defines a second opening, and
wherein the lockout key includes a post portion that is inserted through the first opening and into the second opening to install the lockout key, the first opening aligning with the second opening to allow the post portion to be inserted into the second opening.

16. The system of claim 15, further comprising:
a power cord connected to the handle housing,
wherein the power input is connected to the power cord.

17. The system of claim 12, wherein the gripping portion does not include a power switch separate from the switch mechanism.

18. The system of claim 17, wherein the paddle portion is configured to be manually moved from the first position to the second position by an application of pressure to an underside of the leading end portion of the paddle portion, and
wherein the paddle portion is also configured to be manually moved from the first position to the second position by an application of pressure to a leading side of the protrusion.

19. The system of claim 18, wherein the actuator is configured to be in the ON position when the paddle portion is in the second position and in the OFF position when the paddle portion is in the first position.

20. The system of claim 12, wherein the acute angle is within a range of 20° to 60°.
